(19) United States
(12) Patent Application Publication
(10) Pub. No.: US 2012/0182124 A1
(43) Pub. Date: Jul. 19, 2012

(54) Control and Monitoring Method

(76) Inventor: Michel Joannes, Uccle (BE)

(21) Appl. No.: 13/355,367

(22) Filed: Jan. 20, 2012

Related U.S. Application Data
(63) Continuation of application No. PCT/EP2010/061248, filed on Aug. 3, 2010.

(30) Foreign Application Priority Data
Aug. 10, 2009 (EP) 09167543.9

(51) Int. Cl. G08C 17/02; G08B 29/00; G06K 7/01

(52) U.S. Cl. 340/5.65; 340/10.1

(57) ABSTRACT

Control and monitoring method using:
a plurality of tags for a plurality of “objects” including a human being;—at least one box located at at least one first location;
a computer means at a location remote from the at least one first location; wherein each tag is adapted for wireless sending of a signal with information comprising an identity and/or information relating to the corresponding object and/or environment thereof;
wherein said at least one box is adapted—for receiving said signals,
   for composing an ordered data set comprising at least first information received from a tag and second information received from a tag or from a device coupled to the box, and
   for sending said data set to the computer means; wherein the computer means are adapted to take a decision on such a data set or on a plurality of such data sets.

### CROSS-REFERENCE TO RELATED APPLICATIONS

This application is a Continuation application of International Application Serial No. PCT/EP2010/061248 filed on Aug. 3, 2010; which International application claims priority to the filing date of European Patent Application Serial No. 09167543.9 filed Aug. 10, 2009; the disclosures which applications are herein incorporated by reference.

### INTRODUCTION

1. Field of the invention

The present invention relates to a control and monitoring method, and more specifically: to a control and monitoring method for localizing and checking persons/objects in buildings or confined areas.

2. Background

Monitoring systems using ID tags for tracking certain types of objects/persons are well-known. Typically tags will send messages with their ID to a system to detect the presence of the related object/person.

More specifically, it is known to make an automatic inventory in warehouses using sender and receiver tags communicating with control stations which in turn communicate with a central computer: see US 2003/0209601.

It is also known to check the identity of a person by image processing a photograph of said person and comparing the digitized image with information stored on a tag the person is bearing (on a badge for instance): see U.S. Pat. No. 5,432,864.

In order to localize persons/cars or other moving objects, it is known to use GPS systems, but these systems per definition need the connection to a satellite which is not feasible on a common building and certainly not on an industrial level. Also, they cannot localize persons in confined areas like for instance underground mines. And finally, they are not per se conceived to check abnormalities and send warning signals.

### SUMMARY

The object of embodiments of the invention is to provide an improved control and monitoring system which can be used for controlling different types of objects and/or environments of objects in an improved universal way. More specifically: the invention provides a method for controlling these parameters with relation to human beings.

Therefore, an embodiment of the present invention concerns a control and monitoring method comprising:
wireless receiving at a box of a first signal with first information from a first tag coupled to a person;
receiving at the box of a second signal with second information from a second tag coupled to an object;
sending a data set with said first and second information from the box to remote computer means for taking a decision on said data set or on a combination of such data sets, preferably using predefined rules and the history of the previous pairs.

The idea of an embodiment of the invention is to pair two tags to take a decision.

An embodiment of the method of the invention can control e.g. if the good person is in the good office, if the right worker uses a given tool, if a given pc is used by the right person, if an authorized person gets in a room etc. It can also be used for the following applications:
in case of disaster, for looking after people and sending the rescue teams in the good direction
for checking if a worker is not exposed to dangerous materials/vapours
for controlling nicely and smoothly the access to confidential places like the headquarters of a company. The invention allows controlling the persons in a soft manner.

Embodiments of the invention have many advantages over the other solutions:
a) The fact that the system is based on the pairing of two modules allows a lot of applications with no limitation: the system is open and can evolve. No other system for controlling/watching after persons is based on such a pairing.
b) The system uses a bidirectional connection between modules. It allows sending information and alerts either towards the person or towards a control centre. The other solutions are mono-directional.
c) As the system is completely open, it will be easy to implement it in a first building/location and then gradually increase the implementation to other buildings/locations. According to an embodiment of the invention the control and monitoring method uses a plurality of tags for a plurality of “objects” among which at least one human being; at least one box at at least one first location; and a computer means at a location remote from the at least one first location. Each tag is adapted for wireless sending of a signal with information comprising an identity of the object and/or information relating to the corresponding object and/or the environment thereof. The at least one box is adapted for receiving said signals, for composing an ordered data set comprising at least first information received from a first tag and second information received from a second tag, and for sending said data set to the computer means. In other words each box is adapted for receiving said signals, for combining the received information in an ordered data set, and for sending said data set to the computer means. The computer means are adapted to take a decision on such a data set or on a plurality of such data sets. The computer means will then typically decide if that particular combination of data contained in the data set is allowed and/or if action should to be taken in view of that combination. This is preferably done using predefined rules (for instance: a given place/room may only have a list of authorized persons therein and the system simply tests the tag of an intruder with this list) and the history of the previous pairs (for instance: if an intruder is detected by the system of a given space/room because he is moving near said space/room, the system will use the history in order not to send an alarm of the detection was only temporary).

According to an embodiment each box is adapted for composing an ordered data set by combining the received information of at least a first and a second tag in an ordered data set, and preferably for composing an ordered data pair combining the received information of a first and a second tag in an ordered data pair.

According to an embodiment the computer means are adapted to send feedback to one or more of said at least one box dependent on said decision.

According to an embodiment the at least one box is adapted to generate an ordered data set comprising information received within a certain time frame, and wherein preferably said at least one box is adapted to add to the ordered data set a time representative for the information contained in the data set.

According to an embodiment the ordered data set comprises a data pair, and wherein the decision is “a good pair” or “a bad pair”.

According to an embodiment each tag is further adapted for receiving information from one or more of the at least one box.

The box functions typically as an environmental black box capable of sending data to a computer means. The computer means are typically a server with a database storing the different possible information combinations together with decision information on those data sets. The ordered data sets are for example data pairs with first information received from a first tag and second information received from a second tag. In this case the database can for example contain the allowed data pairs. The server can then take for example a decision that a certain data pair is “a good pair” or “a bad pair”. Note that in the case of sending data pairs it may be possible that only one tag is sending information to the box, the second tag being absent, in which case the data pair will have an empty field, which is information per se.

According to a preferred embodiment each box is adapted to generate an ordered data set comprising at least first and second information received from the first and second tag within a certain time period, and preferably received at substantially the same point in time.

Preferably an ordered data set further comprises the time at which the first or second information were received or the time at which the ordered data set is composed. The time could for example be the time at which the latest information contained in the ordered data set was received. To enable the inclusion of the time there is typically provided a real-time clock. This clock is typically connected with a processing means in the box for processing the signals coming from the tags and for composing the ordered data sets.

According to a further aspect the ordered data sets also comprise an identification of the box where the first and second information was received. This identification can for example be an address such as a MAC address. In that way the server can typically locate the tags sending signals to the box which is fixed. In particular in the case of moving objects such as persons or laptops this may be useful. Also this will allow the server to easily respond to the box, if necessary. According to a further developed embodiment, the computer means are adapted to send feedback to one or more of said at least one boxes dependent on the decision taken by the computer means. The computer means may be adapted further to send feedback to other systems, such as a general alarm system, etc.

According to a preferred embodiment the box is constructed in an indestructible way, comparable to the black box of an airplane. For example, the box may be constructed from steal and glass. Also the box is typically provided with storage means for storing the information received from the tags. Preferably at least the storage means should be contained in the indestructible box. The information received from the tags will typically be stored for only a limited period of time, for example until receipt of an acknowledgement message from the computer means specifying that the ordered data set contained the information from the tags has been received. In that way, in case of a disaster, the latest information of the objects with tags in the neighbourhood of the box will be kept safe and can be recovered after the disaster for analyzing the cause thereof and for avoiding future problems.

According to a possible embodiment each tag is further adapted for receiving messages from the at least one box. In that way a box receiving feedback from the computer means can send where necessary a message to the tag for taking a certain action, e.g. actuating a switch for opening a door in case the object coupled with the tag is a door or activating a built-in alarm in the tag where the tag is coupled to a person.

According to a possible embodiment the plurality of tags comprises first tags of a first type and second tags of a second type. The first tags can be intended for coupling to moving objects (e.g. persons) and the second tags can be intended for coupling to fixed objects (e.g. camera, office, pc, etc), for example.

According to a further developed embodiment a number of boxes and/or a number of tags are provided with alarm means and activation means for the alarm means, wherein the activations means are activated dependent on the feedback of the computer means.

According to a preferred embodiment of the method of the invention at least the first signal and the second signal are received within a certain time frame, e.g. within 1 second. Further a time can be added to the ordered data set. This can for example be the time at which the ordered data set is composed or the receipt time of the latest received tag signal with information contained in the ordered data set.

According to an embodiment of the method of the invention the receiving of the second signal at the box consists in wireless receiving of second information from a second tag coupled to a second object.

According to an embodiment of the method of the invention a time representative for the receipt of the first signal and the second signal is added to the data set.

The invention also relates to the use of a system of the invention, or of a method of the invention for any one of the following applications:
presence or overpopulation detection, wherein a first plurality of tags are coupled with a corresponding number of persons, and a second plurality of tags is coupled with a corresponding number of areas, and wherein a number of boxes is distributed over the number of areas, so that it can be detected which person is in which area at any time; or
parameter detection, such as the detection of a measured concentration or temperature in a certain area, wherein a first tag is coupled to a person and a second tag is coupled to a measurement sensor and is adapted for sending a signal comprising measurement information to a first box present in this area; or—entrance protection, wherein a first tag is coupled to a detection means, such as a camera, and a plurality of second tags are coupled with allowed persons and/or allowed objects; or
information protection, wherein a first tag is coupled to an object, such as a PC, to be protected, and a second tag is coupled to a person allowed to use the object, a first box being present in the sending range of the first tag, wherein, if the first box is not receiving signals of the second tag coupled with the allowed person, the computer means send feedback to the first tag to lock the object.

It is to be noted that the detailed features disclosed below when referring to FIGS. 5-9 may be combined with the applications above in an arbitrary way as will be understood by the skilled person.

According to an embodiment the composing of the data set consists in combining the information received within a certain time frame of at least a first and a second tag in a data set.

According to an embodiment the box further comprises storage means to store said data set, preferably during a certain time period or until an acknowledgement message for said data set is received from the remote computer means.

According to a preferred embodiment, the box is constructed as an indestructible box, preferably comprising storage means to store each data set during a certain period of time or until an acknowledgement message for said data set is received from the computer means.

According to a further aspect the box may be adapted for receiving a message related to the decision from the computer means, and for taking action in line with this message. The box can for example be provided with or coupled with alarm means and activation means for the alarm means, wherein the activation means are activated dependent on the decision.

According to a further developed embodiment the box comprises a transmitter/receiver connected to an antenna for sending and receiving signals to/from neighbouring tags, a processer for processing received information from the tags and for preparing messages to be sent to the server, a storage means for (temporarily) storing information, and a real time clock so that e.g. the time at which information is received from the tags or the time at which an ordered data set is composed can be stored together with the received information and/or added to the ordered data set. The box can be fed by a battery or by a mains supply, for example.

According to a preferred embodiment the tags comprise a transmitter receiver means for sending and receiving signals via an antenna to the box, a storage means for storing an identity of the tag and/or other information, and a processing means for composing messages to be sent to the box and/or for processing messages received from a box. According to an exemplary embodiment a tag can have a built-in alarm means, such as a noise generator or a LED which are activated when receiving an instruction message from the box.

### BRIEF DESCRIPTION OF THE FIGURES

The accompanying drawings are used to illustrate presently preferred non-limiting exemplary embodiments of the present invention. The above and other advantages, features, and objects of the invention will become more apparent and the invention will be better understood from the following detailed description when read in conjunction with the accompanying drawings in which:

FIG. 1 is a schematic diagram of an embodiment of a control and monitoring system that can be used in the method of the invention;

FIG. 2 is a schematic diagram of an embodiment of a box according to the invention;

FIG. 3 is a schematic diagram of an embodiment of a tag that can be used in the method according to the invention;

FIG. 4 is a flowchart of an embodiment of the method performed by the server according to the invention;

FIG. 5 is a schematic diagram of a first exemplary application of the control and monitoring method of the invention;

FIG. 6 is a schematic diagram of a second exemplary application of the control and monitoring method of the invention;

FIG. 7 is a third exemplary application of the control and monitoring method of the invention;

FIG. 8 is a fourth exemplary application of the control and monitoring method of the invention; and

FIG. 9 illustrates a situation in which errors may occur in view of explaining the reduction of errors using the information received at the server.

### DETAILED DESCRIPTION

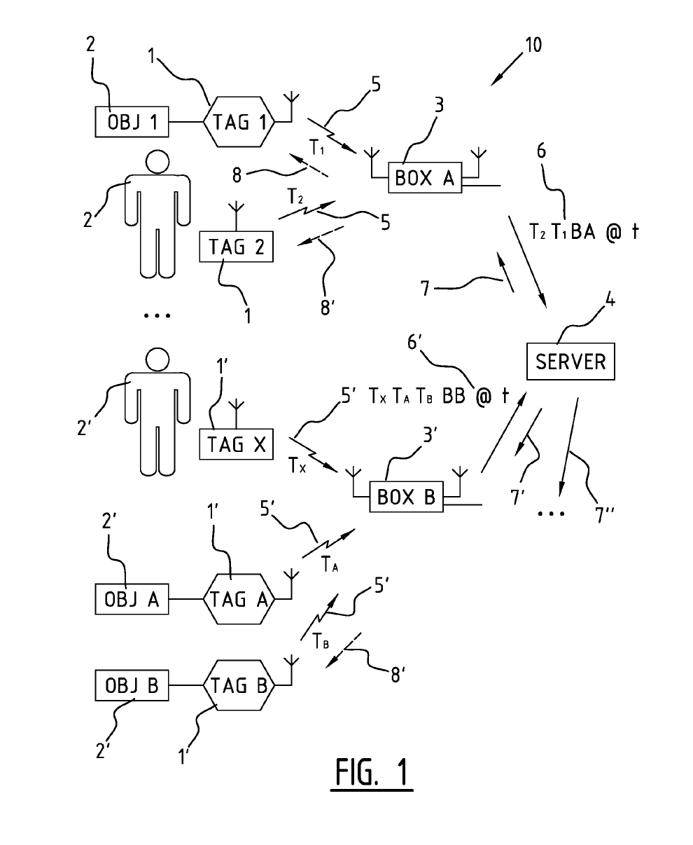

First the basic architecture of an embodiment of the control and monitoring system that can be used in the method of the invention will be set out with reference to FIG. 1. The illustrated embodiment of the control and monitoring system 10 comprises a plurality of tags 1, 1′ for a plurality of objects 2, 2′, a number of boxes 3, 3′, and a server 4.

The tags 1, 1′ can be coupled to a fixed or a moving object. In the neighbourhood of a first box “BOX A”, there is a first tag “TAG 1” coupled to a fixed object “OBJ 1”, and a second tag “TAG 2” coupled to a person. In the neighbourhood of a second box “BOX B”, there is a first tag “TAG X” coupled to a person, a second tag “TAG A” coupled to a first object “OBJ A” and a third tag “TAG B” coupled to a second object “OBJ B”. The tags 1, 1′ can be fixed on the object, e.g. glued or attached with a Velcro or clip, or can be carried by a person (e.g. under a helmet of a worker, in a watch, in a jewel, in the badge of a visitor, etc.), or can be coupled with the object in a different way.

Each tag 1, 1′ is adapted with an antenna to send signals to a neighbouring box 3, 3′, see the arrows 5, 5′. Such a signal typically comprises an identity of the corresponding fixed or moving object 2 or 2′ and/or information relating to the corresponding object and/or to the environment thereof. The information relating to the corresponding object and/or the environment thereof can be for example: a temperature, a concentration (e.g. CO, CO2, etc), a humidity factor, a signal measured by a sensor coupled to the tag, a state of the object, a signal provided by an output device coupled to the tag, etc.

The boxes 3, 3′ are adapted for receiving wireless signals 5, 5′ from the tags 1, 1′. The received information of a number of data tags is combined by the boxes 3, 3′ in respective ordered data sets 6, 6′. The boxes 3, 3′ are adapted to further communicate those ordered data sets by wire or wireless to the server 4.

In the example of FIG. 1 “BOX A” receives information T1 from “TAG 1” and information T2 from “TAG 2” at time t, and combines this information in a data set adding an identity BA of “box A” and a time t, see reference numeral 6. The time t can for example be the time at which the data set 6 was composed. This data pair 6 is then sent to server 4. In a similar way “box B” combines the data from the three tags 1′ (Tx, TA, TB) at time t together with an identification BB of the box in a data set 6′. This data set 6′ is sent to server 4.

The server 4 is provided with program code to take a decision on the received data sets 6, 6′. More in particular the server 4 will verify whether the combination T2 with T1 at time t is allowed, and if necessary a message will be sent to BOX A, see arrow 7. In a similar way the server 4 will take a decision on the data triplet Tx, TA, TB, and if necessary a reaction will be sent to BOX B, see arrow T. It is noted that the server 4 could also decide that a data set is allowed without taking any further action. Another possibility is that the server 4 sends a reaction to a device different from BOX A and BOX B. For example, in the case of a fire, a reaction could be sent to all the boxes 3, 3′ in the plant and/or to a general alarm system.

It is noted that although the example is given for information from different tags at time t, the time t will typically not be the exact receipt time of the signals containing the information. Typically the signals from the different tags will have to be received within a limited time frame in order to be combined in the same data set. In other words the information contained in a data set is derived from signals which have been received with a limited amount of time in between. In practice, the information from signals received from two or more tags within a certain time frame will be combined in an ordered data set 6, 6′. So T2 could be information received at time t while T1 is information received at time t+/−Δt, wherein Δt is smaller than a certain maximum value.

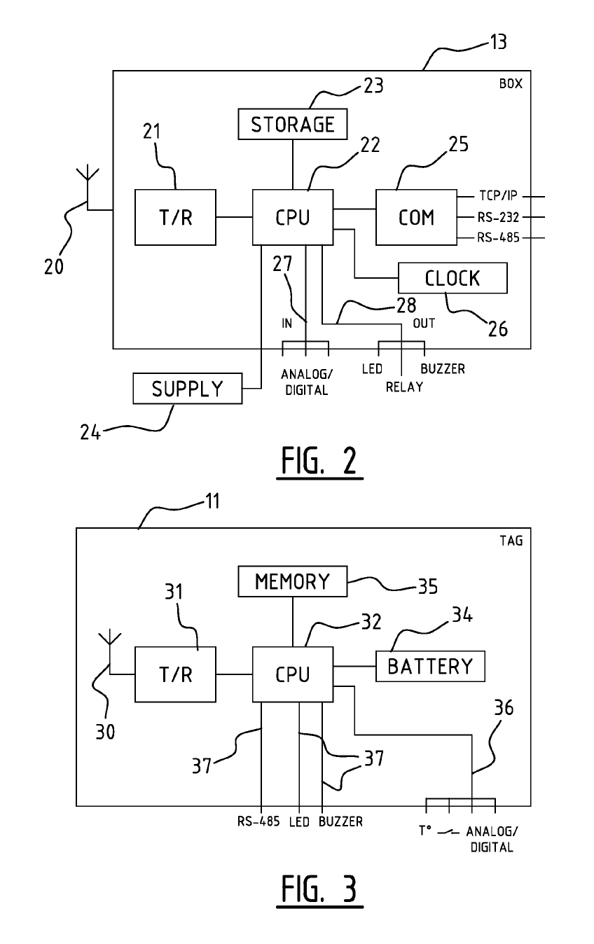

Optionally the boxes 3, 3′ may be further adapted to send signals to the respective tags 1, 1′, see arrows 8, 8′. In that way feedback can be sent to the objects 2, 2′. As an example where the object 2, 2′ is a door, a signal could be sent to a tag coupled with the door to indicate that the door may be opened. Also the boxes 3, 3′ may be further adapted to send signals to other external devices directly coupled with the boxes 3, 3′ (not shown). This will be further set out below with reference to FIG. 2.

Now an embodiment of a box will be described in detail with reference to FIG. 2. The box 13 comprises a transmitter/receiver 21 connected to an antenna 20 for sending and receiving signals to/from neighbouring tags. It is noted that the antenna has been drawn outside the box 13, but could also be located inside the box. Another alternative would be to use two antennas: one inside the box and one outside. The box further comprises a processer 22 for processing received information and for preparing messages to be sent, and a storage means 23 for (temporarily) storing information. The box further comprises a communication module 25 for communicating with the server, e.g. via TCP/IP. Also, serial interface RS-232 and RS-485 may be provided for use on an existent copper wire. This may be useful in case of long distances e.g. in a plant between the box and a TCP/IP connector. Further there is provided a clock 26 so that the time at which information is received from the tags and/or composed can be measured and/or stored together with the received information and/or added to the data sets. The clock of each box will typically be synchronised on a regular basis with the server, or via another suitable technique, in order to limit any time deviations from a common time used in the system. If the location of the boxes is suitable for synchronisation via GPS, this would also be an option. The box 13 can be fed e.g. by a battery, an accumulator or by a mains supply 24. The supply means could be provided outside or inside the box.

According to a possible embodiment the box may be provided with a number of additional input interfaces 27 and/or output interfaces 28. Those input interfaces 27 may be analogue or digital interfaces connected to sensors or other devices for gathering information about e.g. the environment of the box. Examples are sensors for measuring the temperature, the CO2 concentration, the SO2 concentration, the humidity, etc. In that way it is also possible to add data measured by the box in an ordered data set. Further there may be provided a tamper switch (not shown) in the box adapted to indicate that the box has been opened (e.g. by vandalism).

Examples of devices that may be connected to an output interface 28 are a relay, a LED device, a buzzer, a switch, etc. When a decision on a data set is received from the server any one or more of those devices can then be activated.

The box 13 is typically adapted to store locally the information received from the tags, and to only delete this information after receiving an acknowledgment from the server 4 that this information has been received in good order. Further the box is preferably built in an indestructible way. In case of a disaster, where the messages of the box no longer reach the server, it will then be possible to read the content of the memory of the box in order to have the data from just before the disaster. Effectively, the box functions as a black box in an airplane. With such a system the reasons for the disaster can be discovered a posteriori and the necessary actions can be taken to avoid future disasters.

The box can be constructed in an indestructible way using e.g. steel and glass, wherein at least the storage means should be contained in the indestructible part of the box.

Now a detailed embodiment of a tag that can be used in the method according to the invention will be described with reference to FIG. 3. In the embodiment of FIG. 3 the tag 11 comprises a transmitter receiver means 31 for sending and receiving signals via antenna 30 to a box. The tag 11 further comprises a storage means 33 for storing an identity of the tag 35 and/or other information. Further there is provided a processing means 32 for composing messages to be sent or for processing received messages.

The processing means 32 may further be coupled to a number of input devices via input interfaces 36 receiving analogue or digital signals. Examples of such devices are a temperature sensor, a relay, an accelerometer, a switch, etc. The processing means 32 may further be coupled to a number of output lines 37 for directly communicating with a number of output devices. Examples of such devices are a LED, a buzzer, a laptop or computer, etc.

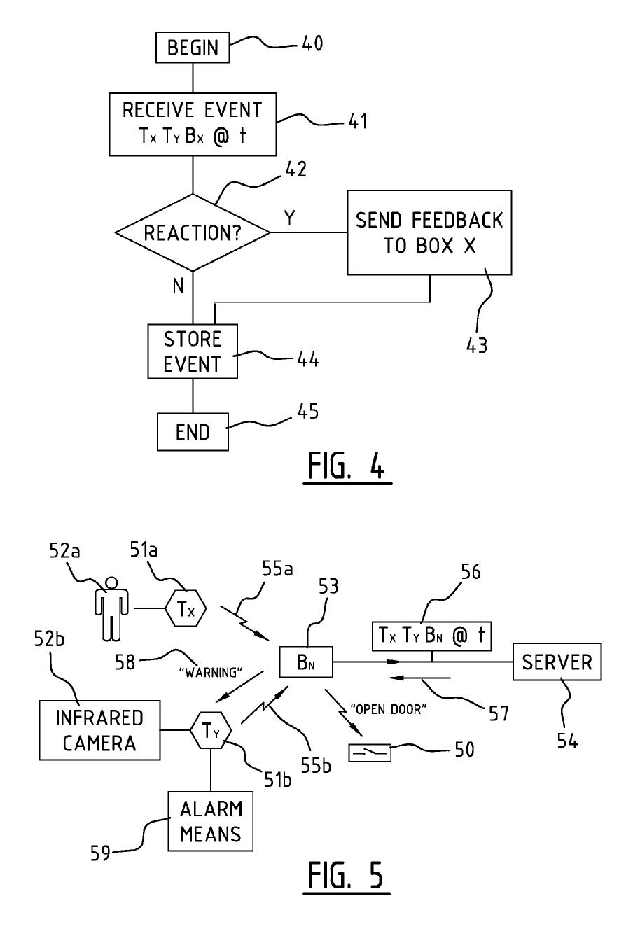

FIG. 4 illustrates schematically an embodiment of the decision making process performed by the server 4. In a first step 41 a signal with event (Tx Ty BX @t) is received from a box X with identification Bx at the server. Tx corresponds with information from a tag X and Ty with information from a tag Y. In step 42 a database is consulted to check whether a reaction is necessary. If an action needs to be taken a feedback signal is sent to BOX X, as illustrated in step 43. After sending the feedback, the event is stored in step 44. If a reaction is not necessary, the event is simply stored in step 44. This process flow can be repeated for every event received at the server. Note that the storing of the event could also take place immediately upon receipt, i.e. between step 41 and step 42.

Note that the server 4 is typically a safe data centre with a database storing all the possible events, together with the reaction to be taken. The server further comprises an application adapted to send instruction messages to different devices, such as one or more boxes 3, 3′ in reaction to the received events.

Now a number of exemplary possibilities of the system and method of the invention will be disclosed with reference to FIGS. 5 to 8.

FIG. 5 illustrates an application where a person 52a with a tag 5 Ia is detected by an infrared camera 52b with a tag 5 Ib. When the infrared camera 52b detects a person, a signal is sent to the box 53. Also the tag 5 Ia of the person will send a signal with his identity Tx to the box 53. The information from the tags 51a/b corresponding with the respective objects 52a/b is combined in a data pair 56 by box 53 and sent to the server 54. The server 54 determines whether the person 52a with identity information Tx may enter the building, and sends a corresponding reaction to box 53, see arrow 57. If the person is allowed to enter the building an “open door” signal will be sent to e.g. a switch 50 for opening a door. If the person is not allowed to enter the building a signal could be sent by box 53 to the tag 5 Ib linked with the infrared camera 52b. The tag 5 Ia may be provided with an alarm means 59, such as a red lamp or a noise generator to inform the person that he is not allowed to enter the building.

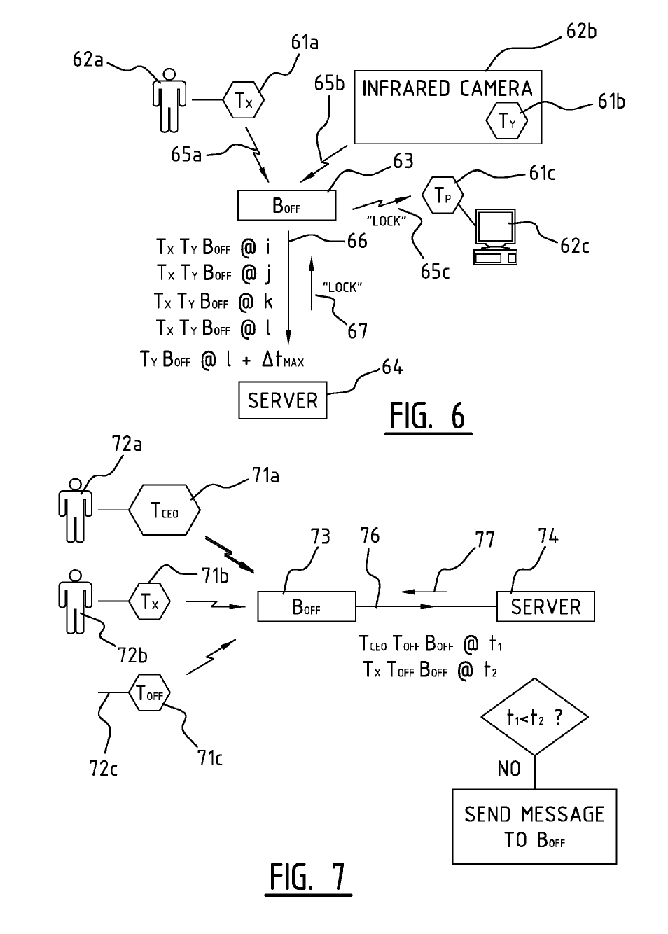

According to an alternative variant a signal could be sent to a reception desk to indicate that a person is waiting before the door and wants to enter the building. The skilled person will understand that there exist many other ways to react to the presence of a non-allowed or non-recognised person within the framework of the invention. According to a second exemplary application, the method of the invention may be used to lock a pc when a person leaves the office. As illustrated in FIG. 6 a person 62a with a tag 61a is detected by an infrared camera 62b with a tag 61b, wherein the tags 61a and 61b send corresponding information Tx, Ty to a box 63. Further there is provided a computer 62c with a tag 61c. The different tags 61a and 61b will send information messages to a box 63 provided in the office or close to the office. As long as the person 62a is in or near the office, the box 63 will send the following n-uples at consecutive points in time:
T_{X} T_{Y} B_{OFF} @ time i
T_{X} T_{Y} B_{OFF} @ time j
T_{X} T_{Y} B_{OFF} @ time k, etc.,
   wherein time k>time j>time i.

When the person 62a leaves the office, the box will send the following data to the server 64:
T_{Y} B_{OFF} @ time 1
T_{Y} B_{OFF} @ time 1+Δt_{MAX},
   wherein Δt_{MAX} is the maximum time period before locking the pc 62. Note that those two data sets contain an empty field indicating that tag X is no longer present and as such containing information on tag X.

If no events indicating that the person 62a is back in the office are received between time 1 and time 1+Δt_{MAX} the server 64 will send a message to the box 63, see arrow 67, to lock the pc 62c, whereupon the box 63 will send a lock message (see arrow 65c) to the tag 61c in order to lock the pc 62c.

FIG. 7 illustrates yet another embodiment of the invention where the server can detect if a person in the office is actually allowed to be there. In the example the office 72c is the office of a CEO and is provided with a tag 71c. In the example the CEO 72a with tag 71a is detected in the office at time t₁. A box 73 with identification B_{OFF} has received the information T_{CEO} and T_{OFF} at time t₁ and has composed and sent the n-uple T_{CEO} T_{OFF} B_{OFF} @ t₁ to the server 74. In a similar way the presence of a person 72b with tag 71b has been detected in the office at time t₂: an n-uple T_{X} T_{OFF} B_{OFF} @ t₂ has been sent to server 74. The server will check whether t₁ is smaller than t₂, in which case the server decides that the situation is normal since the CEO arrived in the office before the other person 72b. If t₂ is smaller than t\ the server sends a message to box 73 (see arrow 77). The box 73 can then take the necessary actions, for example by activating an alarm connected to box 73, or by sending a message to tag 71c if this tag is connected to an alarm device. Also a message could be sent to person 72b to indicate to that he/she is not allowed to be in the office.

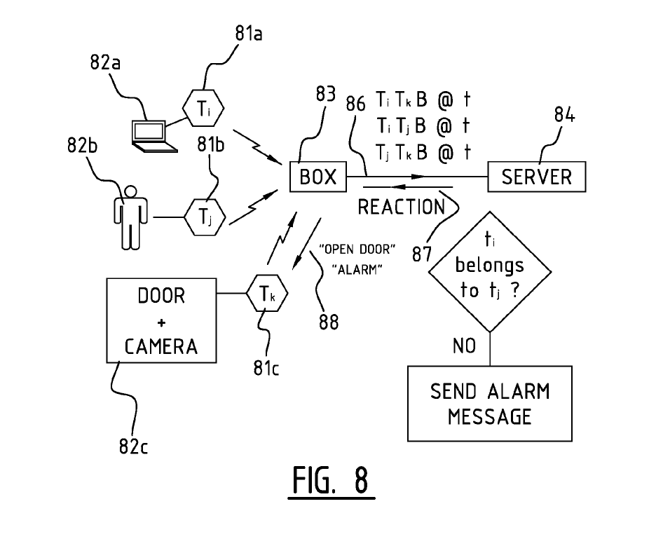

Finally FIG. 8 illustrates a fourth example of an application of the present invention for detecting when a person steals a laptop from the office. In the present example a person 82b with a tag 81b wants to leave the office taking with him a laptop 82a with a tag 81a via a door 82c with a tag 81c. The tags 81a and 81b will send signals with respective information Tᵢ and Tⱼ to a box 83. Also the tag 81c coupled to the door 82c will send a message to the box 83 when the camera associated with the door has detected the person (information Tₖ). The box 83 with identification B composes three data pairs at time t: Tᵢ Tⱼ, B @ t, Tᵢ Tₖ B @ t and Tⱼ Tₖ B @ t. Those data pairs are sent to a server 84. The server will verify whether the laptop 82a belongs to the person 82b by checking the information Tᵢ and Tⱼ in a database. If this is not the case, a reaction message is sent to the box, see arrow 87, and optionally the box will send an alarm message to tag 81c, see arrow 88. If the laptop 82 belongs to the person 82b an “open door” message is sent to tag 81c instead. In that way, if a recognized person has stolen a laptop, this person can be identified. If a person without a tag tries to take out a laptop 82a with a tag 81a, only the n-uple Tᵢ Tₖ B @ t will be sent to the server 84, and no “open door” message will be sent. Also in this case a reaction may be sent to the box 83, whereupon the box can send an alarm message to the tag 81c or to an alarm device. Note that many combinations are possible, wherein a decision can be taken based on a single data pair or on a combination of a number of data pairs received at substantially the same time or at a number of consecutive moments in time.

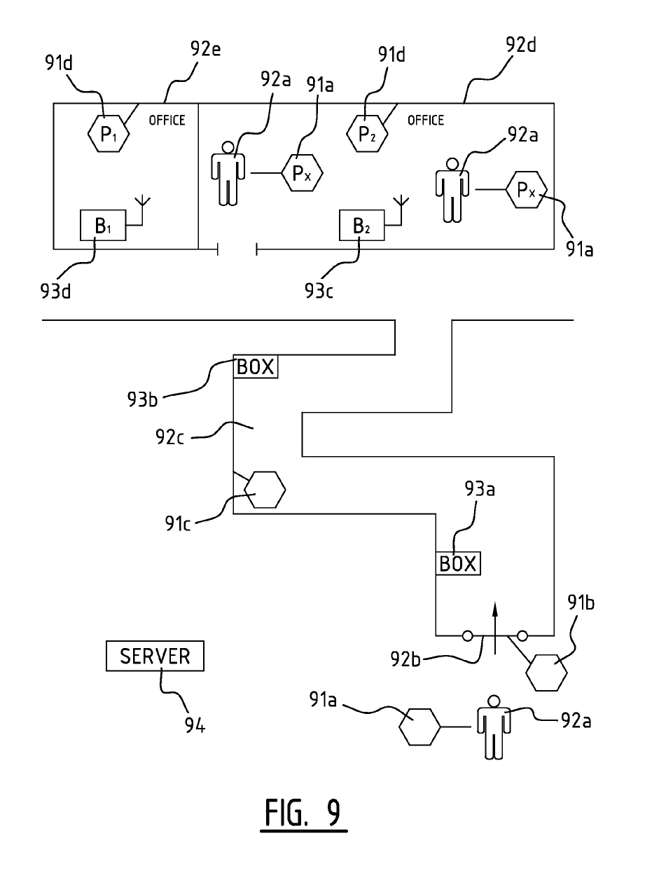

FIG. 9 is used to illustrate how errors may be reduced using the information received by the server. Assume the following example:
a person 92a with a tag 91a enters a building via a door 92b with a tag 91b. The tag 91a of the person 92a will send information Pₓ and the tag 91b of the door 92b will send information Pₖ to a box 93a at time 1.
next this person is walking in the corridor 92c with another tag 91c in the neighbourhood of another box 93b. At times 1-100 this box 93b will send data pairs with information Pₓ of the tag 91a of the person 92a and information of the tag 91c of the corridor to the server 94.

Now person 92 enters in office 92d with a tag 91d with identification information P₂. As illustrated in FIG. 9 there is box 93c in this office with identification B₂. Adjacent to office 92d there is another office 92e with a tag 91e with identification information P₁. Office 92e has a box 93d with identification B₁. When a person is close to the wall between offices 92d en 92e, the box 93d of office 1 will also receive signals sent by tag 91a of the person. At the server 94, as an example, the following information may be received from boxes 93c and 93d:
P_{X}P₂B₂@time 09:01:03
P_{X}P₂B₂@time 09:01:04
P_{X}P₂B₂@time 09:01:05
P_{X}P₂B₂@time 09:01:06
P_{X}P₂B₂@time 09:01:07
P_{X}P₂B₂@time 09:01:08
. . .
P_{X}P₂B₂@time 09:01:12
P_{X}P₂B₂@time 09:01:13
P_{X}P₂B₂@time 09:01:14
P_{X}P₂B₂@time 09:01:15

The server can then decide that the underlined information may be removed for statistical reasons. In that way errors can be reduced.

The applications described above illustrate that the invention has many potentials for improving the security within e.g. a building or company. More in particular the invention is useful for amongst others: presence detection, parameter detection (measured concentration, temperature, etc), overpopulation detection, incident detection, risk management, active security, etc.

While the principles of the invention have been set out above in connection with specific embodiments, it is to be clearly understood that this description is merely made by way of example and does not limit the scope of protection which is determined by the appended claims.

1. Control and monitoring method comprising:
wireless receiving at a box of a first signal with first information from a first tag coupled to a person;
receiving at the box of a second signal with second information from a second tag coupled to an object;
sending a data set with said first and second information from the box to remote computer means for taking a decision on said data set or on a combination of such data sets.

2. Control and monitoring method of claim 1: wherein each tag is wireless sending a signal with information comprising an identity and/or information relating to the corresponding person/object and/or environment thereof to at least one box;
wherein said at least one box
receives said signals,
composes an ordered data set comprising at least first information received from the first tag and second information received from the second tag, and
for sending said data set to the remote computer means; wherein the remote computer means takes a decision on such a data set or on a plurality of such data sets.

3. Control and monitoring method according to claim 1, wherein the remote computer means send feedback to one or more of said at least one box dependent on said decision.

4. Control and monitoring method according to claim 2, wherein the remote computer means send feedback to one or more of said at least one box dependent on said decision.

5. Control and monitoring method according to claim 1, wherein the at least one box generates an ordered data set comprising information received within a certain time frame, and wherein preferably said at least one box adds to the ordered data set a time representative for the information contained in the data set.

6. Control and monitoring method according to claim 2, wherein the at least one box generates an ordered data set comprising information received within a certain time frame, and wherein preferably said at least one box adds to the ordered data set a time representative for the information contained in the data set.

7. Control and monitoring method according to claim 1, wherein the ordered data set comprises a data pair, and wherein the decision is “a good pair” or “a bad pair”.

8. Control and monitoring method according to claim 2, wherein the ordered data set comprises a data pair, and wherein the decision is “a good pair” or “a bad pair”.

9. Control and monitoring method according to claim 1, wherein each tag further receives information from of the box.

10. Control and monitoring method according to claim 2, wherein each tag further receives information from one or more of the at least one box.

11. Control and monitoring method according to claim 1, wherein a time representative for the receipt of the first signal and the second signal is added to the data set.

12. Control and monitoring method according to claim 2, wherein a time representative for the receipt of the first signal and the second signal is added to the data set.

13. Control and monitoring method according to claim 1, wherein the box is indestructible.

14. Control and monitoring method according to claim 2, wherein the box is indestructible.

15. Control and monitoring method comprising:
wireless receiving at a first indestructible box of a first signal with first information from a first tag coupled to a first object;
wireless receiving at the first indestructible box of a second signal with second information from a second tag coupled to a second object;
sending a data set with said first and second information from the first indestructible box to remote computer means for taking a decision on said data set or on a combination of such data sets;
receiving at said first indestructible box feedback of said remote computer means dependent on said decision.

16. Method of claim 15, further comprising:
generating by the first indestructible box of an ordered data set comprising information received within a certain time frame, and wherein preferably said at least one box adds to the ordered data set a time representative for the information contained in the data set.

17. Method of claim 15, further comprising:
receiving at said first tag information from the first indestructible box dependent on the received feedback.

18. Method of claim 15, further comprising: adding a time representative for the receipt of the first signal and the second signal to the data set.

19. Method of claim 15, further comprising:
wireless receiving at a second indestructible box of a third signal with third information from a third tag coupled to a third object;
wireless receiving at the second indestructible box of a fourth signal with fourth information from a fourth tag coupled to a fourth object;
sending a data set with said third and fourth information from the second indestructible box to remote computer means for taking a decision on said data set or on a combination of such data sets;
receiving at said second indestructible box feedback of said remote computer means dependent on said decision.

20. Use of a control and monitoring method according to claim 1:
presence or overpopulation detection, wherein a first plurality of tags are coupled with a corresponding number of persons, and a second plurality of tags is coupled with a corresponding number of areas, and wherein a number of boxes is distributed over the number of areas, so that it can be detected which person is in which area at any time; or
parameter detection, such as the detection of a measured concentration or temperature in a certain area, wherein a first tag is coupled to a person and a second tag is coupled with a measurement sensor and both tags are sending a signal to a box present in this area; or
entrance protection, wherein a first tag is coupled to a detection means, such as a camera, and a plurality of second tags are coupled with allowed persons and/or allowed objects; or
information protection, wherein a first tag is coupled to an object, such as a PC, to be protected, and a second tag is coupled to a person allowed to use the object, a first box being present in the sending range of the first tag, wherein, if the first box is not receiving signals of the second tag coupled with the allowed person, the computer means send feedback to the first tag to lock the object.
